(19) United States
(12) Patent Application Publication
(10) Pub. No.: US 2011/0127796 A1
(43) Pub. Date: Jun. 2, 2011

(54) Grocery cart covering device

(76) Inventor: Wanda G. Fontenot-Martin, Houston, TX (US)

(21) Appl. No.: 12/927,933

(22) Filed: Nov. 30, 2010

Related U.S. Application Data
(60) Provisional application No. 61/283,108, filed on Nov. 30, 2009.

(51) Int. Cl. B60P 7/02

(52) U.S. Cl. 296/100.01

(57) ABSTRACT

A device 10 is provided for covering a grocery cart 12. The device 10 includes a planar shaped member 14 aligned adjacent to the grocery cart 12 for covering the cart. The planar shaped member 14 is provided with first and second diagonally extending side wall members 16 and 18 which engage uppermost portions of the sides 62 and 64 of the cart. Additionally, the planar shaped member includes third and fourth horizontally extending end members 20 and 22 which engage uppermost portions first and second end portions 66 and 68 of the cart 12.

Coupling means 50, 52, 54 and 56 are provided to couple the planar shaped member 14 to the cart 12 so that device 10 is secured over uppermost portions of the cart and the contents of the cart are protected from inclement weather.

### TECHNICAL FIELD

This application claims priority of Provisional Application Ser. No. 61/283,108 filed on Nov. 30, 2009.

This invention relates to grocery shopping carts and more particularly to a device to be used to protect groceries from being ruined when there is inclement weather such as, when it maybe raining and/or snowing.

As we all know, grocery shopping is a necessary part of life. The process may be as simple getting a few items or may become more elaborate thus requiring the use of a grocery cart. One of the more common unpleasant experiences while shopping is discovering inclement weather when coming out of the grocery store. It is not unusual for this to occur. When it does occur one is hardly ever prepared. As a result the shopper has to wait in the store until the weather clears or run the risk of having the purchased goods getting wet and ruined by going into the weather.

The elimination of the possibility of this experience is a necessity. Accordingly it is desirable to provide a simple inexpensive and easily assessable device for preventing purchased groceries from getting spoiled during inclement weather.

### BACKGROUND

There are a number of grocery covering devices today. One device is illustrated in U.S. Pat. No. 5,271,634. The shopping cart cover of this invention is a retractable apparatus. The cover is a vinyl member provided to attach through hooks to the top rail of the forwardly pivoting back rest of the infant seat of the cart when in use. The apparatus includes a vinyl cover spring which is biased to retract the cover into a cylindrical casing when not hooked over a front edge of the basket frame, and the apparatus is not in use.

Although this invention provides an apparatus to accomplish the desired result, because of the different multiple moving parts and size of the apparatus it is not the simple, inexpensive and easily assessable device that is needed.

Another apparatus is disclosed in U.S. Pat. No. 4,960,302. This is also a cover for preventing impingement of inclement weather upon the contents of a grocery cart. This cover includes a top trapeloidal sheet member. The top member has connected to it first and second rectangular sheet members. The first and second sheet members are interconnected by a third, rectangular sheet member attached to the trapeloidal sheet member. The first and second sheet members are disposed on opposite sides of the shopping cart and have attached thereto strips of a material such as Velcro, a string or a rope material so as to secure the cover to the shopping cart.

This cover also because of the different multiple parts and its size is not the simple, inexpensive and easily accessible device that is desired.

In view of the devices that are available it is apparent that a simple, inexpensive and easily assessable cover for the grocery cart during inclement weather is desirable and needed.

### DISCLOSURE OF THE INVENTION

A device for protecting the contents of a grocery cart from inclement weather is provided. The device includes a planar shaped member having diagonally extending side walls. The planar shaped member is aligned adjacent to the grocery cart for covering first and second uppermost portions of the contents of the cart. A first diagonally extending side member is coupled to extend along outer portions of the first side of the planar shaped member for engaging uppermost portions of one side of the cart. A second diagonally extending side member is coupled to extend along outer portions of the second side of the planar shaped member to engaging uppermost portions of another side of the cart. A third horizontally extending end member is coupled to extend along outer portions of a first end of the planar shaped member to engage uppermost portions of a first end of the cart. A means for coupling the third horizontally extending end member between the first and second diagonally extending side members is provided. Additionally, a fourth horizontally extending end member is coupled along outer portions of a second end of the planar shaped member for engaging uppermost portions of a second end of the cart nearest the handle of the cart. The device also includes a means for coupling the fourth horizontally extending side member between the first and second diagonally extending members. A means for coupling the planar shaped member to the cart is provided to secure the member over uppermost portions of the cart so that the contents of the cart are protected.

### BRIEF DESCRIPTION OF THE DRAWING

The details of the invention will be described in connection with accompanying drawing in which:

FIG. 1 is a top view of a grocery cart covering device in accordance with the principles of the invention

FIG. 2 is a perspective view of a grocery cart covering device attached to a grocery cart in accordance with the principles of the invention.

FIG. 3 is a top view of a grocery cart covering device attached to a grocery cart in accordance with the principles of the invention.

FIG. 4 is a top view of a second embodiment of a grocery cart covering device in accordance with the principles of the invention.

FIG. 5 is a perspective view of a second embodiment of a grocery cart covering device attached to a grocery cart in accordance with the principles of the invention.

FIG. 6 is a top view of a second embodiment of a grocery cart covering device attached to a grocery cart in accordance with the principles of the invention.

### BEST MODE FOR CARRYING OUT THE INVENTION

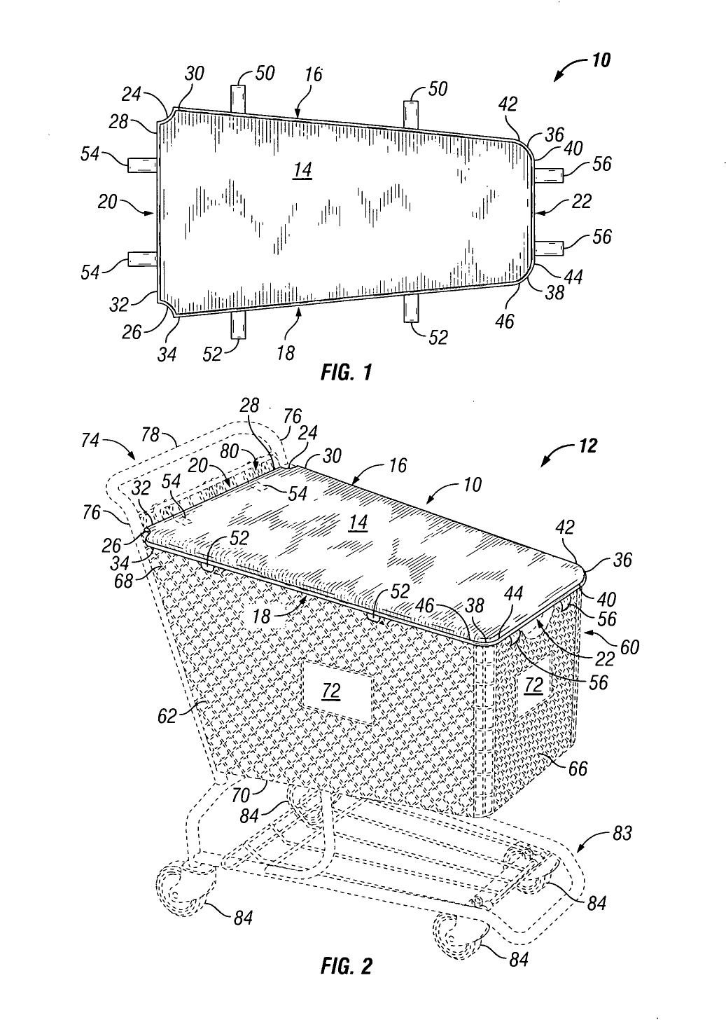

As illustrated in FIGS. 1, 2, and 3 a grocery cart covering device generally designated by the numeral 10 is provided for covering a grocery cart, generally designated, by the numeral, 12 so that the groceries are protected from inclement weather. The grocery cart covering device 10 includes a planar shaped cover member, generally designated by the numeral, 14. The cover member 14 is formed having diagonally extending side walls, generally designated by, the numerals 16 and 18 and end walls, generally designated, by the numerals 20 and 22. The end wall 20 of the cover member 14 is slightly longer than the end wall 22 to facilitate the formation of the diagonally descending configuration of the side walls 16 and 18.

The cart covering device 10 also includes inwardly projecting semi-circularly shaped wall engaging and connecting members 24 and 26. The wall engaging and connecting member 24 connects one end 28 of the end wall 20 to an end 30 of the side wall 16 and the wall engaging and connecting member 26 connects an end 32 of the end wall 20 to an end 34 of the side wall 18 so that the cover member 14 can be properly aligned in a predetermined manner on the cart.

The cart covering device 10 also includes outwardly projecting semi-circularly shaped wall connecting members 36 and 38. The connecting member 36 connects one end 40 of the end wall 22 to an end 42 of the side wall 16. Similarly, the connecting member 38 connects one end 44 of the end wall 22 to an end 44 of the side wall 18.

The cart covering device 10 is also provided with a pair of spaced cart engaging and coupling members 50 and 52 which are coupled to the side walls 16 and 18, respectively and a pair of spaced cart engaging and coupling members 54 and 56 which are coupled to the end walls 20 and 22, respectively. Each of he coupling members 50, 52, 54 and 56 may be a tie member or may be provided for example, with a coupling component member, such as, for example, Velcro or some other adhesive which will facilitate coupling.

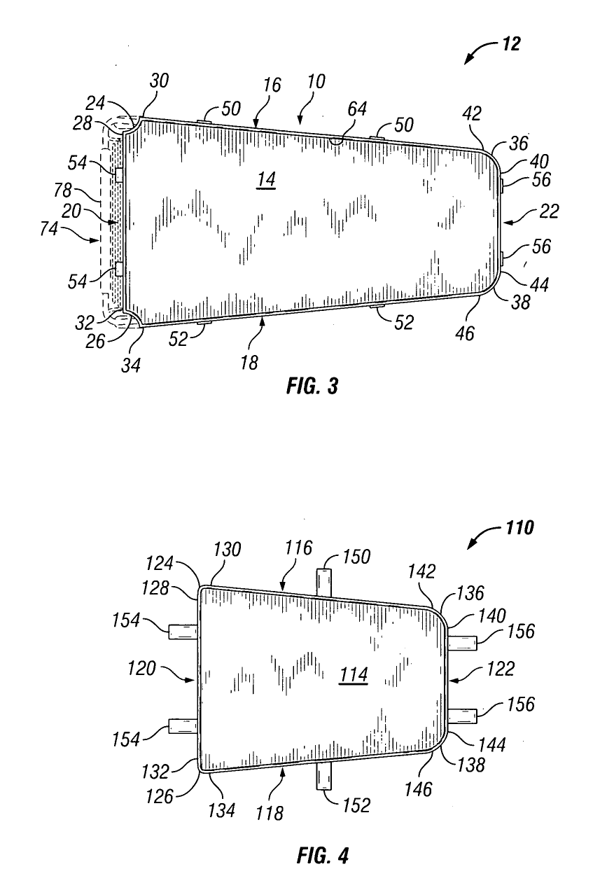

The standard shopping cart 12 (FIG. 2) is provided with a basket 60 having spaced diagonally descending side walls 62 and 64 (FIG. 3) end walls 66 and 68 and a bottom wall member 70 having an open area therebetween for supporting groceries therein. The cart 12 is also provided with a handle, generally designated, by the numeral, 74, having a pair of spaced diagonally elongated members 76, and a grip bar 78 formed therebetween. The cart 12 also includes an infant seat, generally designated, by the numeral 80 (shown closed in FIG. 2).

The basket 60 of the shopping cart 12 is supported on a base member generally designated, by the numeral 82. The base member 82 is provided with wheels 84 which along with the handle 74 allows the cart to be pushed and guided as desired by a user.

When it is desired to secure the grocery cart covering device 10 to the cart 12 the device is positioned on the cart as is illustrated in FIGS. 2 and 3. As is shown the device 10 is positioned on the cart 12 so that side walls 16 and 18 are in adjacent alignment to engage corresponding uppermost portions of the side walls 62 and 64 and so that end walls 20 and 22 are aligned to adjacently engage corresponding upper portions of end walls 66 and 68 of the cart. When the device 10 is positioned in this manner the basket 12 and the infant seat 80 are covered.

A second embodiment of a grocery cart covering device, generally designated, by the numeral 110 is illustrated in FIGS. 4, 5, and 6. The covering device 110 is provided for covering a grocery cart, generally designated, by the numeral, 12 when the infant seat 80 is in use. The grocery cart covering device 110 includes a planar shaped cover member, generally designated by the numeral, 114. The cover member 114 is formed having diagonally extending side walls, generally designated by the numeral 116 and 118 and end walls, generally designated, by the numerals 120 and 122. As illustrated in FIG. 1, the end wall 120 is slightly longer than the end wall 122. The cart covering device 110 also includes outwardly projecting perpendicularly shaped wall engaging and connecting members 124 and 126. The wall engaging and connecting member 124 connects one end 128 of the end wall 120 to an end 130 of the side wall 116 in a predetermined configuration. The wall engaging and connecting member 126 connects an end 132 of the end wall 126 to an end 134 of the side wall 118.

The cart covering device 110 in this embodiment also includes outwardly projecting semi-circularly shaped wall connecting members 136 and 138. The connecting member 136 connects one end 140 of the end wall 122 to end 142 of the side wall 116. Similarly, the connecting member 138 couples one end 144 of the end wall 122 to an end 146 of the side wall 118.

The cart covering device 110 is also provided with cart engaging and coupling members 150 and 152 which are coupled to the side walls 116 and 118, respectively, and a pair of spaced cart engaging and coupling members 154 and 156 which are coupled to the end walls 120 and 10 122, respectively. Each of he coupling members 150, 152, 154 and 156, as in the first embodiment may be ties or may be provided with a coupling component, such as, for example, Velcro or some other adhesive to facilitate coupling.

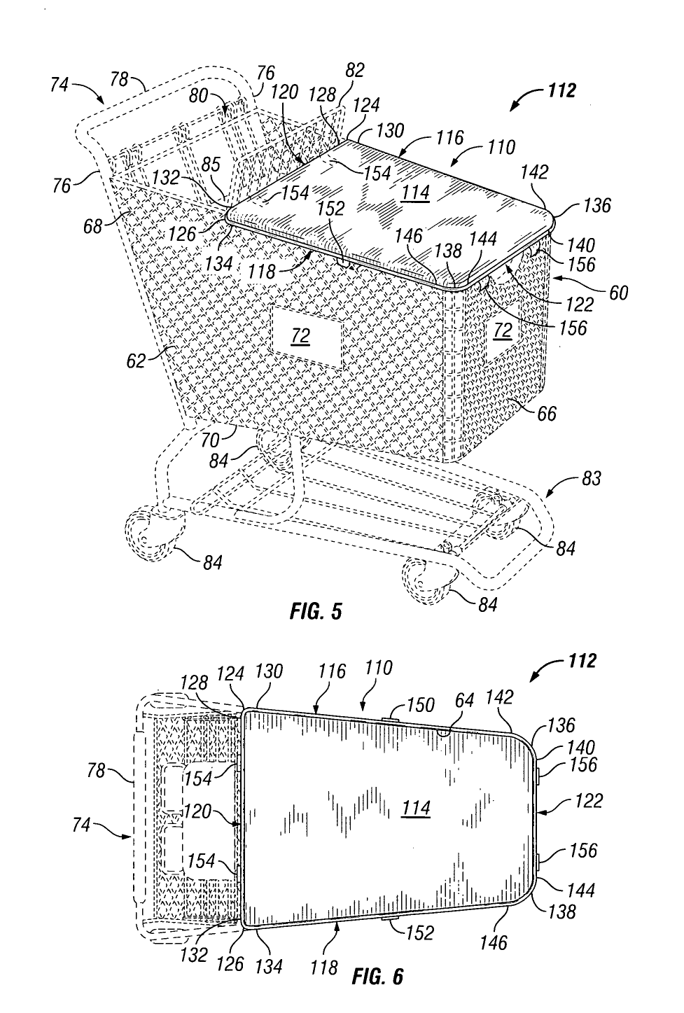

As illustrated in FIG. 5, the cart 12 is provided with an infant seat, generally designated, by the numeral 80 (shown in a open position). The infant seat 80 includes a back support member 82, and a seat 85 on which an infant sits. The back support 82 is pivotable toward the end 68 of the cart 12 in a well known member so that the seat is moved to an upright position when the seat is not in use.

When it is desired to secure the grocery cart covering device 110 to the cart 12 the device is positioned as is illustrated in FIGS. 5 and 6. As is shown the device 110 is aligned with the cart 12 so that the side walls 116 and 118 adjacently engage corresponding uppermost portions of the side walls 62 and 64 of the cart. The end wall 120 of the cover member 114 is aligned to rest right behind and engage the back support 82 of the infant seat 80 and the end wall 122 engages an upper portion of the 10 end wall 66 of the cart. When the device 10 is positioned in this manner the infant seat 80 of the cart is not covered. However, the groceries in the cart 12 are still protected.

The grocery cart covering devices of this invention may be made, for example, of a clear plastic or some other similar durable material which is lightweight, inexpensive and moisture resistant.

It should be understood that various changes and modifications can be made without departing from the spirit of the invention as defined in the following claims.

What is claimed:

1. A device for covering a grocery cart and protecting the contents of the cart from inclement weather including:
a planar shaped member aligned adjacent an uppermost portion of the cart for covering first and second uppermost portions thereof;
a first diagonally extending side member, included in the planar shaped member, coupled to extend along outer portions of the first side of the planar shaped member for engaging uppermost portions of one side of the cart;
a second diagonally extending side member, included in the planar shaped member, coupled to extend along outer portions of a second side of the planar shaped member for engaging uppermost portions of another side of the cart;
a third horizontally extending end member, included in the planar shaped member, coupled to extend along outer portions of a first end of the planar shaped member for engaging uppermost portions of a first end of the cart;
first means included in the planar shaped member, for coupling the third horizontally extending end member between the first and second diagonally extending side members;
a fourth horizontally extending end member, included in the planar shaped member, which is longer than the third horizontally extending end member coupled along outer portions of a second end of the planar shaped member for engaging uppermost portions of a second end of the cart adjacent the handle of a cart;
second means, included in the planar shaped member, for coupling the fourth horizontally extending end member between the first and second diagonally extending side members; and
means for coupling the planar shaped member to the cart so that the member is secured over uppermost portions of the cart and the contents of the cart are protected.

2. A device as defined in claim 1 wherein the first coupling moans includes:
a first outwardly projecting semi-circularly shaped engaging and connecting member having a first end thereof coupled to a first end of the first downwardly extending side member and a second end thereof coupled to a first end of the third longitudinally extending end member; and
a second outwardly projecting semi-circularly shaped engaging and connecting member having a first end thereof coupled to a first end of the second diagonally extending side member and a second end thereof coupled to a first end of the third horizontally extending end member.

3. A device as defined in claim 2 wherein the second coupling means includes:
a first inwardly projecting semi-circularly shaped engaging and connecting member having a first end thereof coupled to a second end of the first diagonally extending side member, and a second end thereof coupled to a first end of the fourth horizontally extending end member; and
a second inwardly projecting semi-circularly shaped engaging and connecting member having a first end thereof coupled to a second end of the second diagonally extending side member and a second end thereof coupled to the fourth horizontally extending member so that the first inwardly projecting engaging and connecting member is aligned adjacent a first diagonally extending elongated portion of the cart handle, and so that the second inwardly projecting engaging and connecting member is aligned adjacent a second diagonally extending elongated portion of the cart handle.

4. A device as defined in claim 3 wherein the planar shaped member coupling means includes:
a first pair of spaced engaging and coupling members coupled to the first diagonally extending side member;
a second pair of spaced engaging and coupling members coupled to the second diagonally extending side member;
a third pair of spaced engaging and coupling members coupled to the third horizontally extending end member; and
a fourth pair of spaced engaging and coupling members coupled to the fourth horizontally extending end member, each of the pair of spaced engaging and coupling members being aligned to couplingly engage adjacent portions of the cart.

5. A device for covering a grocery cart and protecting the contents of the cart from inclement weather including:
a planar shaped member aligned adjacent an uppermost portion of the cart for covering a first uppermost portions thereof;
a first diagonally extending side member, included in the planar shaped member, coupled to extend along outer portions of the first side of the planar shaped member for engaging predetermined portions of uppermost portions of one side of the cart;
a second diagonally extending side member, included in the planar shaped member, coupled to extend along outer portions of a second side of the planar shaped member for engaging predetermined portions of uppermost portions of another side of the cart;
a third horizontally extending end member, included in the planar shaped member, coupled to extend along outer portions of a first end of the planar shaped member for engaging uppermost portions of a first end of the cart;
first means for coupling the third horizontally extending end member between the first and second diagonally extending side members;
a fourth horizontally extending end member, included in the planar shaped member, which is longer than the third horizontally extending end member coupled along outer portions of a second end of the planar shaped member for engaging intermediate uppermost portions of the cart adjacent the infant seat back support member the cart;
second means for coupling the fourth horizontally extending end member between the first and second diagonally extending side members; and
means for coupling the planar shaped member to the cart so that the member is secured over uppermost portions of the cart and the contents of the cart are protected.

6. A device as defined in claim 5 wherein the first coupling means includes:
a first outwardly projecting semi-circularly shaped engaging and connecting member having a first end thereof coupled to a first end of the first downwardly extending side member and a second end thereof coupled to a first end of the third longitudinally extending end member; and
a second outwardly projecting semi-circularly shaped engaging and connecting member having a first end thereof coupled to a first end of the second diagonally extending side member and a second end thereof coupled to a first end of the third horizontally extending end member.

7. A device as defined in claim 6 wherein the second coupling means includes;
a first outwardly projecting perpendicularly shaped engaging and connecting member having a first end thereof coupled to a second end of the first diagonally extending side member, and a second end thereof coupled to a first end of the fourth horizontally extending end member; and
a second outwardly projecting perpendicularly shaped engaging and connecting member having a first end thereof coupled to a second end of the second diagonally extending side member and a second end thereof coupled to the fourth horizontally extending member so that the first outwardly projecting perpendicularly shaped engaging and connecting member is aligned adjacent a first end portion of the cart infant seat back support member, and so that the second outwardly projecting perpendicularly shaped engaging and connecting member is aligned adjacent a second end portion of the cart infant seat back support member.

8. A device as defined in claim 7 wherein the planar shaped member coupling means includes:
a first engaging and coupling member coupled to the first diagonally extending side member;
a second engaging and coupling member coupled to the second diagonally extending side member;
a third pair of spaced engaging and coupling members coupled to the third horizontally extending end member; and
a fourth pair of spaced engaging and coupling members coupled to the fourth horizontally extending end member, each of the engaging and coupling members being aligned to couplingly engage adjacent portions of the cart.
